(19) United States
(12) Patent Application Publication
(10) Pub. No.: US 2018/0007291 A1
(43) Pub. Date: Jan. 4, 2018

(54) IMAGE PROCESSING APPARATUS, IMAGE CAPTURING APPARATUS, IMAGE PROCESSING METHOD, AND NON-TRANSITORY COMPUTER-READABLE STORAGE MEDIUM

(71) Applicant: CANON KABUSHIKI KAISHA, Tokyo (JP)

(72) Inventors: Yoshiaki Ida, Utsunomiya-shi (JP); Chiaki Inoue, Utsunomiya-shi (JP); Yuichi Kusumi, Utsunomiya-shi (JP)

(21) Appl. No.: 15/627,491

(22) Filed: Jun. 20, 2017

(30) Foreign Application Priority Data
Jul. 1, 2016 (JP) 2016-131322

(51) Int. Cl. H04N 5/357; H04N 5/225; H04N 5/232; G06T 3/40

(52) U.S. Cl. CPC H04N 5/357; H04N 5/23293; H04N 5/2258; G06T 3/4076; G06T 3/4038

(57) ABSTRACT

An image processing apparatus (120) that generates a virtual light source image of an object, includes a generator (103a) that generates the virtual light source image based on light source information and normal information of the object and a determiner (103b) that determines noise reduction information to be used for noise reduction processing based on the normal information.

### BACKGROUND OF THE INVENTION

### Field of the Invention

The present invention relates to an image processing apparatus which reduces a noise in a virtual light source image of an object.

### Description of the Related Art

Conventionally, an image processing technology (for example, computer graphics: CG) for reproducing the appearance of an object based on light source information and physical information such as shape and reflection characteristics of the object is known. Particularly, a technology of capturing an actual object under a certain light source environment and reproducing the appearance under a light source environment virtually set later by image processing is called rewriting. Although there is lighting using a strobe or a reflector as a technology of photography, it is difficult to take pictures as intended because equipment and photographer skills are required, and correction after photography is also impossible. The rewriting can solve these problems.

In general, since the physical information of the object is unknown, it is acquired by using various methods. For example, shape information is acquired from distance information by a method such as a triangulation method using laser light and a binocular stereo method. Meanwhile, surface normal information of an object, instead of a three-dimensional shape, may be acquired by an illuminance difference stereo method or the like. A method of acquiring reflection characteristics from an image acquired by capturing an object while changing a light source environment and a visual line direction is known. The reflection characteristics may be expressed as models such as bidirectional reflectance distribution function (BRDF) together with the surface normal information. Japanese Patent Laid-open No. 2013-235537 discloses an image creating apparatus that performs rewriting based on a depth map acquired by various methods and reflection characteristics estimated by image recognition.

Acquired errors are included in the acquired shape and reflection characteristics. When the rewriting is performed based on the information including these errors, luminance noise occurs in the virtual light source image (rewriting image) that reproduces the appearance of the object. The magnitude of the luminance noise is not uniquely determined from the acquired error of the shape or the reflection characteristics but varies from region to region depending on the light source information to be reproduced, the shape of the object, and the reflection characteristics. Accordingly, if noise reduction processing is performed without considering this change, residual noises and blurring occur, and a reproduced image with satisfactory image quality cannot be obtained. However, Japanese Patent Laid-open No. 2013-235537 does not disclose the noise reduction processing.

### SUMMARY OF THE INVENTION

The present invention provides an image processing apparatus, an image capturing apparatus, an image processing method, and a non-transitory computer-readable storage medium which are capable of effectively reducing a noise included in a virtual light source image of an object.

An image processing apparatus as one aspect of the present invention generates a virtual light source image of an object, and includes a generator configured to generate the virtual light source image based on light source information and normal information of the object, and a determiner configured to determine noise reduction information to be used for noise reduction processing based on the normal information.

An image capturing apparatus as another aspect of the present invention includes an image capturer configured to photoelectrically convert an optical image formed via an image capturing optical system, and the image processing apparatus.

An image processing method as another aspect of the present invention generates a virtual light source image of an object, and includes the steps of generating the virtual light source image based on light source information and normal information of the object, and determining noise reduction information to be used for noise reduction processing based on the normal information.

A non-transitory computer-readable storage medium as another aspect of the present invention stores an image processing program which causes a computer to execute the image processing method.

Further features of the present invention will become apparent from the following description of exemplary embodiments with reference to the attached drawings.

### BRIEF DESCRIPTION OF THE DRAWINGS

FIG. 1 is a block diagram of an image processing apparatus in each of Embodiments 1 to 3.

FIG. 2 is a flowchart of noise reduction processing in Embodiment 1.

FIG. 3 is a table of noise amount data in each embodiment.

FIG. 4 is an explanatory diagram of a reflection characteristic in each embodiment.

FIG. 5 is a flowchart of noise reduction processing in Embodiment 2.

FIG. 6 is a flowchart of noise reduction processing in Embodiment 3.

FIG. 7 is a flowchart of noise reduction processing in Embodiment 4.

FIG. 8 is a block diagram of an image processing apparatus in Embodiment 4.

FIG. 9 is an explanatory diagram of variables of the reflection characteristic in each embodiment.

### DESCRIPTION OF THE EMBODIMENTS

Exemplary embodiments of the present invention will be described below with reference to the accompanied drawings.

An image processing apparatus of this embodiment can effectively reduce a noise included in a virtual light source image of an object. Before describing specific embodiments, the outline of this embodiment will be described below. Each embodiment of the present invention relates to rewriting for reproducing the appearance of the object under a virtually set light source environment. The appearance of the object is physically determined by shape information of the object, reflection characteristic information of the object, and light source information.

As a type of the shape information, for example, there is distance information. The distance information can be acquired by a known method such as triangulation using laser light and binocular stereo. It is also effective to use normal information on an object surface. This is because the physical behavior of the reflected light when the light from the light source is reflected by the object depends on the local surface normal. Accordingly, when acquiring the shape information of the object as the 3D shape or the distance information, it is necessary to acquire the normal information from these pieces of information. As a method of directly acquiring the surface normal information, there are known methods such as a method utilizing polarization and an illumination difference stereo. The normal information means a normal direction vector or each degree of freedom representing a normal.

The reflection characteristic is a characteristic that uniquely determines the intensity of reflected light in association with a light source direction when light enters the object with a certain intensity. In general, the reflection characteristic also depends on the surface normal of the object and the visual line direction to observe. Therefore, the reflection characteristic f is represented by expression (1).

i=E·f(s,v,n,X) (1)

In expression (1), symbol i is a luminance of reflected light, symbol E is a luminance of incident light, symbol s is a unit vector (light source direction vector) indicating a direction from the object to the light source, symbol n is a unit surface normal vector of the object, and symbol v is a unit vector (visual line vector) indicating an observation direction from the object. These relations are illustrated in FIG. 9 as an explanatory diagram of variables of the reflection characteristic. When the reflection characteristic is expressed as a parametric model, a coefficient vector X of the reflection characteristic model is also used as a variable. The coefficient vector X has a dimension equal to the number of coefficients. Reflection characteristic information indicates a reflection characteristic f or a coefficient of the reflection characteristic model. Parametric models include, for example, Lambertian reflex model, Oren-Nayer model, Phong model, Torrance-Sparrow model, and Cook-Torrance model, and objects that can adapt to the model are limited. For example, the Lambert reflection model adapts to a uniformly diffusing object because it does not depend on the visual line direction, and it is preferred that an object which changes the appearance depending on the visual line direction is expressed by another model which depends on the visual line vector. These models are often used in combination, and a diffuse reflection component and a specular reflection component are represented by different models, and the reflection characteristic of the object is often expressed as a sum thereof. Specular reflection light is specular reflection on the object surface and it indicates Fresnel reflection according to the Fresnel equation on the object surface (interface). Diffuse reflection light indicates light scattered inside the object to be returned after transmitting through the surface of the object. In general, reflected light of an object includes each of components of the specular reflection light and the diffuse reflection light.

The light source information includes information on the intensity of the light source, the position of the light source, the direction of the light source, the wavelength of the light source, the size of the light source, the frequency characteristic of the light source, and the like, but is not limited thereto.

An image processing apparatus in this embodiment is an image processing apparatus that generates a virtual light source image of an object, and it includes a generator (virtual light source image generator 103a) and a determiner (noise reduction information determiner 103b). The generator generates the virtual light source image based on the light source information and the normal information of the object. The determiner determines noise reduction information to be used for the noise reduction processing based on the normal information. Thus, by using the light source information and the normal information of the object, the virtual light source image of the object can be generated. When information acquired from an actual object is used instead of the virtually set information, the virtual light source image also includes noise. By performing the noise reduction processing for reducing the noise based on the normal information of the object, it is possible to effectively reduce the noise included in the virtual light source image of the object.

The generator may generate the virtual light source image further based on the reflection characteristic information of the object. By using the reflection characteristic information of the object, it is possible to generate the virtual light source image that reproduces a texture of the object such as reflectance, glossy feeling, and surface roughness of the object.

The determiner may determine the noise reduction information further based on the light source information. When setting a light source condition in generating the virtual light source image, the noise included in the virtual light source image of the object can be effectively reduced by determining the noise reduction information also based on the light source information.

The determiner may determine the noise reduction information further based on the reflection characteristic information. When setting the reflection characteristic information in generating the virtual light source image, the noise included in the virtual light source image of the object can be effectively reduced by determining the noise reduction information also based on the reflection characteristic information.

The determiner may determine the noise reduction information based on a reflectance determined by the reflection characteristic information. When generating the virtual light source image, the influence of an error included in the normal information or the reflection characteristic information gets strong with increasing the reflectance. The reflectance is a reflectance considering the incident angle and the reflection angle of the light source, and it is, for example, BRDF. Accordingly, by determining the noise reduction information based on the reflectance, it is possible to obtain the virtual light source image where the noise has been effectively reduced.

The determiner may determine the noise reduction information based on the sensitivity of the reflection characteristic information with respect to the normal information. Even when the normal light information is acquired with a constant amount of noise in generating the virtual light source image, as the sensitivity with respect to the normal information of the reflection characteristic is higher, the noise becomes larger as a luminance value of the virtual light source image. Accordingly, by determining the noise reduction information based on the sensitivity with respect to the normal information of the reflection characteristic, it is possible to obtain the virtual light source image where the noise has been effectively reduced.

The reflection characteristic information is represented by a parametric model and the determiner may determine the noise reduction information based on the sensitivity with respect to a coefficient of the parametric model of the reflection characteristic information. Even when the coefficient of the reflection characteristic model is acquired with a constant amount of noise in generating the virtual light source image, as the sensitivity with respect to the coefficient of the reflection characteristic is higher, the noise becomes larger as a luminance value of the virtual light source image. Accordingly, by determining the noise reduction information based on the sensitivity with respect to the coefficient of the reflection characteristic, it is possible to obtain the virtual light source image where the noise has been effective reduced.

The determiner may determine the noise reduction information based on information on the intensity of the light source in the light source information. When generating the virtual light source image, the influence of the error included in the normal information or the reflection characteristic information gets strong with increasing the intensity of the incident light. Accordingly, by determining the noise reduction information based on the light source intensity, it is possible to obtain the virtual light source image where the noise has been effectively reduced.

The determiner may determine the noise reduction information based on the information on a spatial distribution of the light sources in the light source information. The spatial distribution of the light source is the intensity distribution of a point light source when the light source environment is considered as a group of point light sources. When expressing the light source distribution, it is possible to perform a frequency analysis by expanding light sources in all directions seen from a point on the object with a spherical harmonic function. The spatial frequency (frequency characteristic) of the light source distribution obtained in this way greatly affects the appearance of the object. The smaller a spatial frequency component of the light source distribution is, the more the change of the normal or the reflection characteristic at the spatial frequency does not affect the appearance of the object. Similarly, an amount of luminance noise of the virtual light source image caused by a frequency normal information error or a reflection characteristic information error changes in accordance with the magnitude of the spatial frequency component included in the light source distribution in generating the virtual light source image. Accordingly, by determining the noise reduction information based on the frequency characteristic of the light source, it is possible to obtain the virtual light source image where the noise has been effectively reduced.

The determiner may determine the noise reduction information based on a luminance value of the virtual light source image (which is determined, for example, by the light source information and the reflection characteristic information). When generating the virtual light source image, the influence of the error included in the normal information or the reflection characteristic information gets strong with increasing the luminance depending on the light source information and the reflection characteristic information. Accordingly, by determining the noise reduction information based on the luminance value of the virtual light source image, it is possible to obtain a virtual light source image where the noise has been effectively reduced.

The determiner may determine the noise reduction information based on the normal error information. Depending on an acquisition condition of the normal information, an error amount of the acquired normal information may be different. For example, when acquiring the normal information of the object using polarized information, the degree of polarization changes depending on the direction of the normal of the object or the material of the object, resulting in different error amounts depending on the region. Accordingly, by determining the noise reduction information based on the normal error information, it is possible to obtain the virtual light source image where the noise is effectively reduced.

The determiner may determine the noise reduction information based on the reflection characteristic error information. Depending on the acquisition condition of the reflection characteristic information, the error amount of the acquired reflection characteristic information may be different. For example, when measuring the BRDF of the entire circumference while moving the light source or the image capturing apparatus, the amount of luminance noise varies depending on the reflectance of the object, resulting in a different error amounts depending on the region. Accordingly, by determining the noise reduction information based on the reflection characteristic error information, it is possible to obtain the virtual light source image where the noise has been effectively reduced.

The generator may generate the virtual light source image further by using the visual line information, and the determiner may determine the noise reduction information further based on the visual line information. When controlling the visual line direction in generating the virtual light source image or handling the reflection model depending on the visual line direction, it is necessary to obtain visual line information such as a visual line direction and a viewpoint position in reproducing a virtual appearance of the object. Since the reflection characteristic of the object depends on the visual line information, by determining the noise reduction information based on the visual line information, it is possible to obtain the virtual light source image where the noise has been effectively reduced.

The noise reducer (noise reduction processor 103c) may perform the noise reduction processing on the normal information by using the noise reduction information. The noise reduction of the normal information may be performed by a known method, and the known noise reduction processing can be performed assuming that, for example, each degree of freedom is equivalent to the luminance value of the image. By reducing the noise reduction of the normal information using the light source information, the normal information, and the reflection characteristic information, it is possible to reduce variations of the surface normals with appropriate parameters considering generation of the virtual light source images. By generating the virtual light source image using the normal information (surface normal information), it is possible to obtain a high-quality virtual light source image with less residual noise and blurring.

The noise reducer may perform the noise reduction processing on the reflection characteristic information by using the noise reduction information. The noise reduction of the reflection characteristic information can be performed by using known noise reduction processing, for example, considering the parameters of the reflection model to be equivalent to the luminance value of the image. By performing the noise reduction of the reflection characteristic information using the light source information, the normal information, and the reflection characteristic information, it is possible to reduce variations of the reflection characteristic information with an appropriate parameter considering the generation of the virtual light source image. By generating the virtual light source image using the reflection characteristic information, it is possible to obtain a high-quality virtual light source image with less residual noise and blurring.

The noise reducer may perform the noise reduction processing on the virtual light source image using the noise reduction information. The virtual light source image indicates an image obtained by reproducing the appearance of the object by image processing when various light source conditions such as a position, an intensity, an angle characteristic, a wavelength, and the number of light sources are changed. The light source condition used as a virtual light source may be a virtually created, or a condition of a light source in an environment for viewing images or a light source separately obtained from a real environment.

The noise reducer may perform the noise reduction processing on at least one reflection component image contributing to the virtual light source image using the noise reduction information. When the diffuse reflection component and the specular reflection component are used as individual parametric models as the reflection characteristic of the object in generating the virtual light source image, it is possible to obtain the virtual light source image (reflection component image) corresponding to each reflection component. In general, the diffuse reflection component and the specular reflection component have greatly different luminance and sensitivity with respect to each variable, and therefore by performing the noise reduction processing for each reflection component image, considering the property of the reflection component, a high-quality virtual light source image which suppresses residual noises or blurring can be obtained. Further, there are cases where the intensity is adjusted for each reflection component for changing the texture of the object when generating the virtual light source image. By performing the noise reduction processing for each reflection component image when separately performing operations for each reflection component, it is possible to obtain the virtual light source image where the noise has been effectively reduced.

The noise reducer may perform the noise reduction processing on the virtual light source image by at least one light source contributing to the virtual light source image. It is possible to obtain a final virtual light source image as a sum of the virtual light source images by the respective divided light sources by dividing the light source into a plurality of light sources according to the linearity of the luminance value in generating the virtual light source image. Further, the influence of the error of the normal information or the reflection characteristic information on the luminance value of the virtual light source image varies depending on the position, intensity, frequency characteristic, or the like of the light source. Accordingly, by performing the noise reduction processing on the virtual light source image by each divided light source, it is possible to obtain the virtual light source image where the noise has been effectively reduced.

The noise reduction information may be different for each region of the object. Further, the determiner may determine the noise reduction information based on luminance correction processing performed on the virtual light source image. The normal information, the reflection characteristic information, and the error information thereof are different for each region of the object. Also for the light source information, in order to improve the appearance, there is a case where the virtual light source image where light from the light source having different intensities and orientations is incident for each region of the object. Accordingly, by determining the noise reduction information for each region of the object, it is possible to obtain the virtual light source image where the noise has been effectively reduced.

Hereinafter, the image processing apparatus (image capturing apparatus) of the present embodiment will be specifically described in each embodiment.

### Embodiment 1

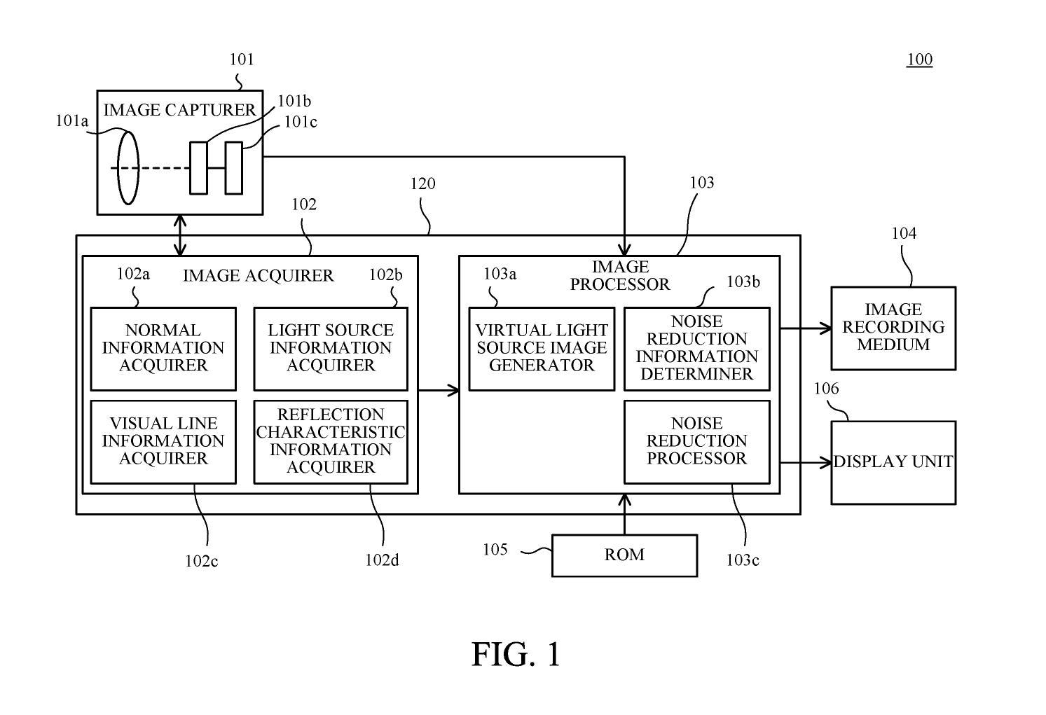

First, referring to FIG. 1, an image capturing apparatus (image processing apparatus) in Embodiment 1 of the present invention will be described. FIG. 1 is a block diagram of an image capturing apparatus 100 in this embodiment.

In FIG. 1, an image capturer (image capturing unit) 101 includes an image capturing optical system 101a (imaging lens), an image sensor 101b, and an A/D converter 101c. The image capturing optical system 101a forms an image of light from an object (not illustrated) on the image sensor 101b. The image sensor 101b includes a photoelectric conversion element such as a CCD sensor and a CMOS sensor, and it photoelectrically converts an object image (optical image) formed via the image capturing optical system 101a to output image data (analog signal). The analog signal generated by the photoelectric conversion of the image sensor 101b is converted into a digital signal by the A/D converter 101c to be output to an image processing apparatus 120 (image processor 103). In this embodiment, the image capturing optical system 101a (lens apparatus) is detachably attached to the image capturing apparatus body including the image sensor 101b. However, this embodiment is not limited thereto, and the image capturing optical system 101a and the image capturing apparatus body may be integrally configured.

An information acquirer 102 includes a normal information acquirer 102a, a light source information acquirer 102b, a visual line information acquirer 102c, and a reflection characteristic information acquirer 102d. The normal information acquirer 102a, the light source information acquirer 102b, the visual line information acquirer 102c, and the reflection characteristic information acquirer 102d acquire, from the image capturer 101, the normal information, the light source information, the visual line information, and the reflection characteristic information for generating the virtual light source image, respectively.

The image processor 103 includes a virtual light source image generator 103a, a noise reduction information determiner 103b, and a noise reduction processor 103c. The virtual light source image generator 103a (generator) generates the virtual light source image based on data (the normal information, the light source information, the visual line information, and the reflection characteristic information) output from the information acquirer 102. The noise reduction information determiner 103b (determiner) determines the noise reduction information based on data (the normal information, the light source information, the visual line information, and the reflection characteristic information) output from the information acquirer 102. The noise reduction processor 103c performs the noise reduction processing on the virtual light source image. In this embodiment, the information acquirer 102 and the image processor 103 constitute the image processing apparatus 120.

Further, the image capturing apparatus 100 includes an image recording medium 104, a ROM 105, and a display unit 106. The image where the noise reduction processing has been performed (i.e., noise reduction image) is output to and recorded on the image recording medium 104 such as a semiconductor memory and an optical disk, or it is output to and displayed on the display unit 106. The ROM 105 is a storage unit (memory) that stores various data and programs used in image processing by the image processor 103. For example, the ROM 105 stores noise data (virtual light source image noise amount calculated previously by simulation) of virtual light source images related to data such as light source information, normal information, visual line information, and reflection characteristic information.

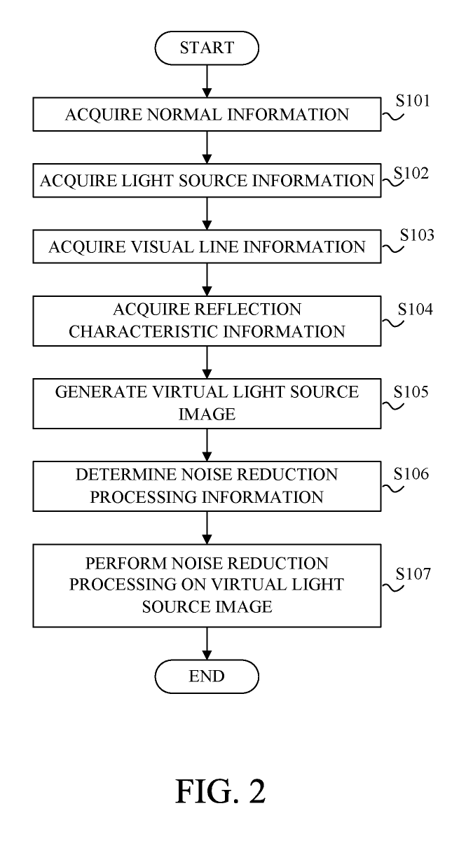

Next, referring to FIG. 2, the noise reduction processing (image processing method) in this embodiment will be described. FIG. 2 is a flowchart of the noise reduction processing in this embodiment. Each step of FIG. 2 is performed by each unit of the image capturing apparatus 100 (image processing apparatus 120). Furthermore, the noise reduction processing of this embodiment is performed by a computer such as a CPU included in the image processing apparatus 120 according to an image processing program as a computer program. Instead of performing the noise reduction processing of this embodiment on software, it may be configured to perform the noise reduction processing on a circuit as hardware.

First, at step S101, the normal information acquirer 102a acquires the normal information for generating the virtual light source image. In this embodiment, the normal information acquirer 102a acquires a distance map (distance information) which is two-dimensional depth information acquired in advance, and obtains a differential (difference) of the depth information to calculate the normal information. The distance map can be acquired from, for example, a parallax image acquired by the image capturer 101 or information acquired by a known method such as Depth From Defocus. When directly acquiring the normal information map, distance information of the object may be acquired separately for calculation of visual line information described below.

Subsequently, at step S102, the light source information acquirer 102b acquires the light source information for generating the virtual light source image. In this embodiment, a user inputs desired light source information. The light source information includes, but is not limited to, the intensity, position, light source direction, and wavelength of the light source. Further, various types of spot light sources or surface light sources may be prepared in advance, the user may select an appropriate type from among them, and parameters such as a light source size and a spread angle of light may be set as needed. In addition, light source data acquired from a real environment can be read as light source information, and the light source information in an image viewing environment may be captured in real time. Further, different light source information can be set for each region on the screen (image), and a plurality of pieces of light source information may be acquired.

Subsequently, at step S103, the visual line information acquirer 102c acquires the visual line information for generating the virtual light source image. For example, by setting a viewpoint at a position separated from the center of the virtual light source image by the distance information acquired at step S101, the visual direction for each pixel can be acquired based on the distance information and the position on the image.

Subsequently, at step S104, the reflection characteristic information acquirer 102d acquires the reflection characteristic information for generating the virtual light source image. For the reflection characteristic information, for example, a coefficient set of a parametric model may be assigned to each pixel, and a value acquired by measuring the object in advance may be used, or the user may arbitrarily set it. Further, a plurality of pieces of reflection characteristic information may be acquired, for example by acquiring the diffuse reflection components and the specular reflection components separately. At steps S101 to S104, it is only necessary to acquire information necessary for generating the virtual light source image, and it is not necessary to be in the order illustrated in the flowchart of FIG. 2. In other words, the order of steps S101 to S104 can be arbitrarily changed, and at least a part of these steps may be performed in parallel as necessary.

Subsequently, at step S105, the information acquirer 102 communicates (transmits) the normal information, the light source information, the visual line information, and the reflection characteristic information acquired at steps S101 to S104 to the image processor 103. Then, the virtual light source image generator 103a generates the virtual light source image based on these pieces of information. The intensity and direction of light incident on each point on the object are determined based on the light source information. Therefore, based on the reflection characteristic information, the luminance value of the virtual light source image can be uniquely determined as a function of the normal information and the visual line information. When a plurality of pieces of light source information are acquired at step S102 or when a plurality of pieces of reflection characteristic information are acquired at step S104, each of the virtual light source images corresponding to a plurality of pieces of light source information and reflection characteristic information, respectively, may be separately generated. A final virtual light source image can be generated by correcting the plurality of pieces of virtual light source images generated in this way so that a final exposure is appropriate to be added with an arbitrary ratio. The plurality of images to be added may include not only the virtual light source image but also the actually captured image. Step S105 may be performed after step S106 described below.

Subsequently, at step S106, the noise reduction information determiner 103b determines the noise reduction information based on the normal information, the light source information, the visual line information, and the reflection characteristic information acquired at steps S101 to S104 by using a method described below. In this embodiment, a virtual light source image noise amount σr is used as the noise reduction information. The noise amount is the standard deviation of the noise distribution. Since the virtual light source image includes luminance information, the virtual light source image noise amount σr is a luminance noise amount on the virtual light source image.

The virtual light source image noise amount or is noise amount data of the virtual light source image with respect to various data of the light source information, the normal information, the visual line information, and the reflection characteristic information, and the noise amount data may be previously calculated by simulation and stored in the ROM 105. In this embodiment, noise amount data for all combinations of various data may be discretely calculated. Alternatively, the noise amount caused by each of the various data may be calculated, and the noise amount as a whole may be obtained by using a propagation rule of errors in a multivariable function as described below. When determining the noise reduction information, the noise amount when matching the actual various data may be acquired from the ROM 105. The virtual light source image noise amount or may be stored for each image capturing condition such as the ISO sensitivity of the image capturer 101 at the time of acquiring the distance information and the luminance level of the captured image.

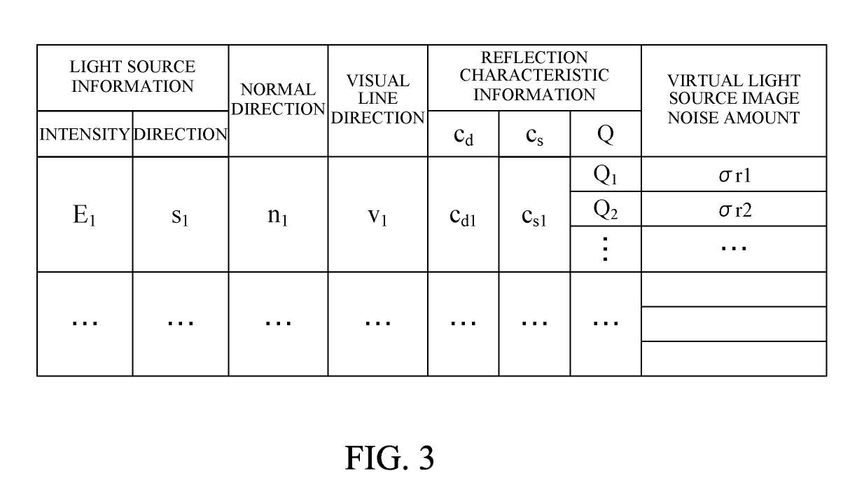

Referring to FIG. 3, a table of specific noise amount data will be described. FIG. 3 is a table of noise amount data. As illustrated in FIG. 3, the noise reduction information can be determined by storing the virtual light source image noise amount or with respect to the various data in the ROM 105 or the like.

Here, the principle that the virtual light source image noise amount or changes with respect to the various data will be described. In this embodiment, expression (1) representing the reflection characteristic is represented by the sum of the diffuse reflection component according to the Lambertian reflection model and the specular reflection component according to the simple Torrance-Sparrow model as represented by expression (2) Will be described.

$$i = E \cdot f ( s , v , n , {c}_{d} , {c}_{s} , Q ) = {c}_{d} s \cdot n + \frac{{c}_{s}}{v \cdot n} exp [ - \frac{{α}^{2}}{2 {Q}^{2}} ] \qquad ( 2 )$$

In expression (2), symbol a is an angle between the bisector direction of the light source direction s and the visual line direction v and the normal direction n of the surface (see FIG. 9). It is assumed that the coefficient vector X of the reflection characteristic model of expression (1) is composed of a diffuse reflectivity c_{d}, a specular reflectance cₛ, and a surface roughness Q.

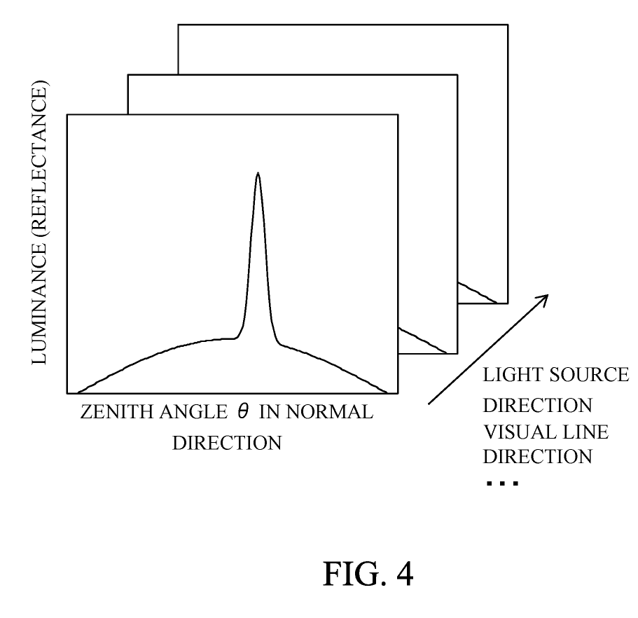

FIG. 4 is an explanatory diagram of the reflection characteristic of expression (2). As illustrated in FIG. 4, the reflection characteristic is a multivariable function based on the normal information, the light source information, the visual line information, the reflection characteristic information (parameters of the reflection characteristic model), and the like. In this embodiment, the reflection characteristic represents the change in reflectance by a zenith angle component θ in a surface normal direction n of the normal information, but a value or an inclination of the reflectance changes depending on the value of the zenith angle θ or other information. Accordingly, even if the normal information can be acquired with a constant precision (noise amount) with respect to the zenith angle θ, the magnitude of the luminance noise varies when generating the virtual light source image. By determining the noise reduction information depending on this change, it is possible to effectively reduce the influence of the noise in generating the virtual light source image. In this embodiment, the change in the reflectance with respect to the zenith angle θ is described, but the same applies to other variables. Further, when a plurality of variables include errors, the noise amount as a whole may be obtained using the propagation rule of errors described above. For example, when the zenith angle θ, the azimuth angle φ, and the diffuse reflectance c in the normal direction n are used as the information for determining the noise amount data, the virtual light source image noise amount σr is represented by expression (3) below.

σr²=(∂i/∂θ)²σ_{θ}²+(∂i/∂φ)²σ_{φ}²+(∂i/∂c_{d})²σ_{cd}² (3)

In expression (3), symbols σ_{θ}, σ₁₀₀, σ_{cd} are noise amounts of the zenith angle θ in the normal direction n, the azimuth angle φ, and the diffuse reflectance cd, respectively. Symbols ∂i/∂θ, ∂i/∂φ, ∂i/∂c_{d} correspond to sensitivities of respective parameters of the reflection characteristic considering the luminance E of the incident light. If there is a correlation between the noise amounts of two or more variables, covariance may also be considered. When σ_{θ}, σ_{φ}, σ_{cd} are unknown, it is impossible to obtain accurate noise amounts, but it is only necessary to acquire the virtual light source image noise amount σr under the assumption that the error in the normal direction is a certain constant value.

The format of the data table is not necessarily as illustrated in FIG. 3, but it may include error information of each variable or at least one of variables may not be included. For example, when the reflection characteristic information does not depend on the visual line information, it is not necessary to hold the visual line information. Further, when the normal information can be acquired with high accuracy and the influence of the reflection characteristic information is dominant, the error amount of the normal information does not have to be considered. The virtual light source image noise amount σr may be acquired for each region of a certain range in the virtual light source image or may be acquired for each pixel.

When a plurality of pieces of light source information is acquired at step S102, when a plurality of pieces of reflection characteristic information are acquired at step S104, or when a plurality of virtual light source images are generated at step S105, the noise reduction information may be determined for each virtual light source image.

When there are a plurality of light sources, expression (2) is represented by expression (4) below.

$$i = {\sum }_{k} {E}_{k} \cdot f ( {s}_{k} , v , n , {c}_{d} , {c}_{s} , Q ) = {\sum }_{k} \{ {c}_{d} {s}_{k} \cdot n + \frac{{c}_{s}}{v \cdot n} exp [ - \frac{{α}_{k}^{2}}{2 {Q}^{2}} ] \} \qquad ( 4 )$$

The same applies to the case where the light source size of the virtual light source has a finite size. When the light source distribution does not include the high frequency component, the high frequency noise is suppressed and thus the noise reduction information may be weakened accordingly.

Subsequently, at step S107 of FIG. 2, the noise reduction processor 103c performs the noise reduction processing by a method described below. The image where the noise reduction processing has been performed is output to and recorded on the image recording medium 104 such as a semiconductor memory or an optical disc, or it is output to the display unit 106 for display. As the noise reduction processing, a known method of the noise reduction processing for an image can be used, and for example, a bilateral filter represented by expression (5) may be used.

$$g ( i , j ) = \frac{\begin{matrix}{\sum }_{n = - w}^{w} {\sum }_{m = - w}^{w} f ( i + m , j + n ) exp ( - \frac{{m}^{2} + {n}^{2}}{2 {σ}_{1}^{2}} ) \\ exp ( - \frac{{( f ( i , j ) - f ( i + m , j + n ) )}^{2}}{2 {σ}_{2}^{2}} )\end{matrix}}{\begin{matrix}{\sum }_{n = - w}^{w} {\sum }_{m = - w}^{w} exp ( - \frac{{m}^{2} + {n}^{2}}{2 {σ}_{1}^{2}} ) \\ exp ( - \frac{{( f ( i , j ) - f ( i + m , j + n ) )}^{2}}{2 {σ}_{2}^{2}} )\end{matrix}} \qquad ( 5 )$$

In expression (5), symbols i and j are the position of the target pixel, symbol f(i,j) is the virtual light source image generated at step S105, symbol g(i,j) is the virtual light source image after the noise reduction processing, symbol w is a filter size, symbol of is a spatial direction dispersion value, and symbol σ2 is a luminance value direction dispersion value. By using the virtual light source image noise amount σr as the luminance value direction variance value σ2, the noise reduction processing depending on the noise amount of the virtual light source image as a result can be performed.

The virtual light source image to be subjected to the noise reduction processing need not be the image itself generated at step S105. For example, an image where image processing other than the noise reduction processing, such as deconvolution processing, edge enhancement, high resolution processing including super-resolution processing like Richardson-Lucy method, demosaicing processing, luminance correction processing like level correction and gamma correction, has been performed may be used. In this case, since the noise amount varies with changes in luminance due to image processing, changes in spatial frequency characteristics, and the like, the noise reduction information may be determined based on information of the image processing.

As described above, in this embodiment, an example of using the bilateral filter as a method of the noise reduction processing is described, but the present invention is not limited thereto. The noise reduction processing may be performed according to the normal information noise amount on depending on the light source information or the virtual light source image noise amount or, and other noise reduction methods may be used.

### Embodiment 2

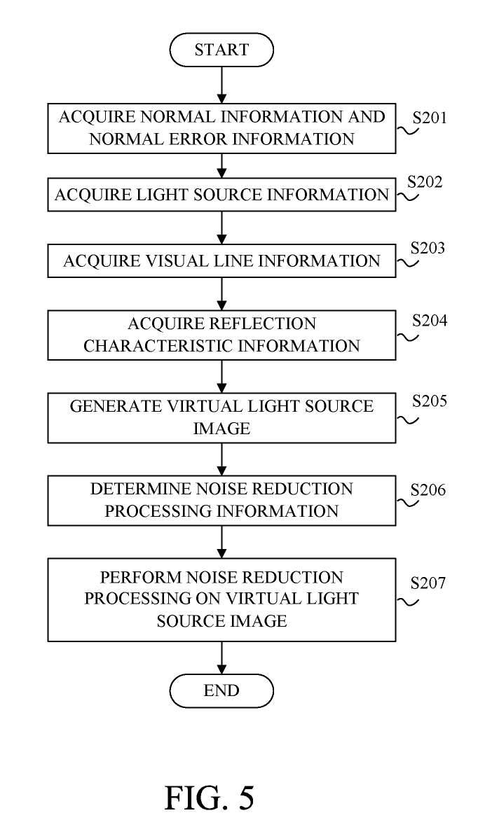

Next, referring to FIG. 5, noise reduction processing in Embodiment 2 of the present invention will be described. FIG. 5 is a flowchart of the noise reduction processing in this embodiment. Each step of FIG. 5 is performed by each unit of the image capturing apparatus 100 (image processing apparatus 120).

The basic configuration of the image capturing apparatus (image processing apparatus) of this embodiment is the same as that of Embodiment 1. The noise reduction processing of this embodiment is different from Embodiment 1 in that the noise reduction information determiner 103b determines the noise reduction information further based on an error amount (normal error information) of the normal information. Steps S202 to S205 of FIG. 5 are the same as steps S102 to S105 of Embodiment 1 described referring to FIG. 2, respectively, and thus description thereof will be omitted.

In this embodiment, when the normal information acquirer 102a acquires the normal information at step S201, it acquires the normal error information as well. The normal error information is the error amount (noise amount) of a value of each degree of freedom of the normal, and information when acquiring the normal information may be recorded. For example, similarly to Embodiment 1, when calculating the normal information from the parallax image acquired by the image capturer 101, a variation (variation in acquisition) of the depth information depending on the base length and the depth between the captured viewpoints is calculated, and the variation of the normal information may be calculated. This variation is the normal error information. When there is an error of the normal information (acquired error), a luminance noise occurs in the virtual light source image generated by using the normal information in accordance with the error amount. Accordingly, by determining the noise reduction information depending on the error amount, it is possible to effectively reduce the noise occurring in the virtual light source image.

When the normal error information at the time of acquisition is not recorded, the normal line noise amount may be directly calculated from the normal information. MAD (Median Absolute Deviation) can be used as a method of calculating the normal noise amount. The MAD performs wavelet transformation on the captured image and is calculated as represented by expression (6) below with a wavelet coefficient w_{HH1} of the acquired highest frequency subband image HH1.

MAD=median(|w_{HH1}−median(w_{HH1})|) (6)

The normal noise amount on included in the normal information can be estimated from the fact that the MAD and the standard deviation satisfy the relationship of expression (7) below.

σn=MAD/0.6745 (7)

At step S206, the noise reduction information determiner 103b determines the noise reduction information based on the normal information, the light source information, the visual line information, the reflection characteristic information, and the normal error information acquired at steps S201 to S204.

Subsequently, at step S207, similarly to step S107, the noise reduction processor 103c performs the noise reduction processing. The noise reduction processing may be performed on the normal information rather than on the virtual light source image. For example, when the noise reduction processing is performed on the zenith angle θ in the normal direction n, the noise amount of the zenith angle θ itself is not the virtual light source image noise amount σr but the noise amount 94 _{θ} of the zenith angle θ, and accordingly σ_{θ} is used as σ₂. However, with respect to the noise amount σ_{θ} of the zenith angle θ, the virtual light source image noise amount σr varies depending on various data such as the normal information, the light source information, the visual line information and the reflection characteristic information. Accordingly, by changing σ₁ depending on the various data, the noise reduction processing depending on the virtual light source image noise amount σr can be performed on the normal information. In this case, with respect to the noise amount σ_{θ} of the zenith angle θ and acquired various information, it is preferred that σ₁ which is a desired noise amount after the noise reduction processing may also be held as the noise reduction information.

### Embodiment 3

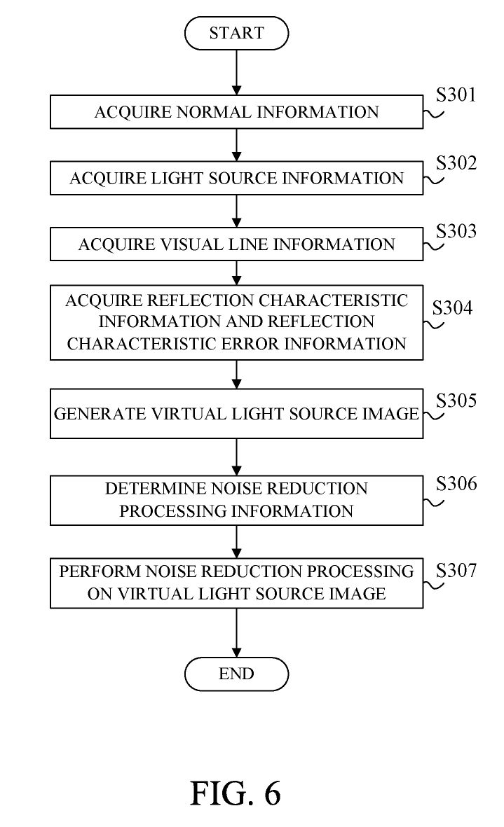

Next, referring to FIG. 6, noise reduction processing in Embodiment 3 of the present invention will be described. FIG. 6 is a flowchart of the noise reduction processing in this embodiment. Each step of FIG. 6 is performed by each unit of the image capturing apparatus 100 (image processing apparatus 120).

The basic configuration of the image capturing apparatus (image processing apparatus) of this embodiment is the same as that of Embodiment 1. The noise reduction processing of this embodiment is different from Embodiment 1 in that the noise reduction information determiner 103b determines the noise reduction information further based on an error amount (reflection characteristic error information) of the reflection characteristic information. Steps S301 to S303 and S305 in FIG. 6 are the same as steps S101 to S103 and S105 in Embodiment 1 described referring to FIG. 2, respectively, and thus descriptions thereof will be omitted.

In this embodiment, when the reflection characteristic information acquirer 102d acquires the reflection characteristic information at step S304, it acquires the reflection characteristic error information as well. The reflection characteristic error information is an error amount (noise amount) of each of variables when representing the reflection characteristic as a parametric model or error information of reflectance calculated by using the parametric model, and information when acquiring the reflection characteristic information may be recorded. For example, a measurement error when measuring the BRDF while changing the light source direction or the observation direction is recorded. When there is an acquired error of the reflection characteristic information, a luminance noise occurs in the virtual light source image generated by using the reflection characteristic information corresponding to the error amount. Accordingly, by determining the noise reduction information depending on the error amount, it is possible to effectively reduce the noise occurring in the virtual light source image. When the reflection characteristic error information at the time of acquisition is not recorded, similarly to the case of the normal error information, the noise amount of the reflection characteristic information may be calculated directly from the reflection characteristic information.

At step S306, the noise reduction information determiner 103b determines the noise reduction information based on the normal information, the light source information, the visual line information, the reflection characteristic information, and the reflection characteristic error information acquired at steps S301 to S304. Subsequently, at step S307, similarly to step S107, the noise reduction processor 103c performs the noise reduction processing. Further, instead of performing the noise reduction process on the virtual light source image, it may perform the noise reduction processing on the reflection characteristic information similarly to the case of the normal information.

### Embodiment 4

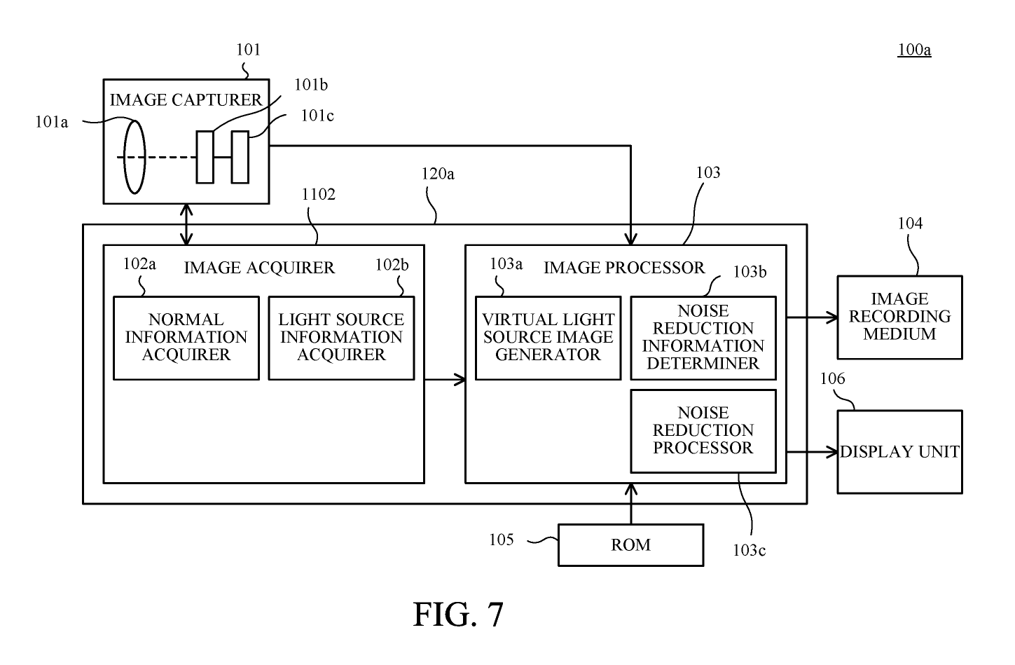

Next, referring to FIG. 7, an image capturing apparatus (image processing apparatus) in Embodiment 4 of the present invention will be described. FIG. 7 is a block diagram of an image capturing apparatus 100a in this embodiment.

The image capturing apparatus 100a of this embodiment is different from the image capturing apparatus 100 of each of Embodiments 1 to 3 in that the image capturing apparatus 100a includes an information acquirer 1102 (image processing apparatus 120a) which does not include the visual line information acquirer 102c and the reflection characteristic information acquirer 102d, instead of the information acquirer 102 (image processing apparatus 120). In this embodiment, the visual line information and the reflection characteristic information are determined in advance, and the image capturing apparatus 100a (image processing apparatus 120a) performs the noise reduction processing using predetermined visual line information and reflection characteristic information.

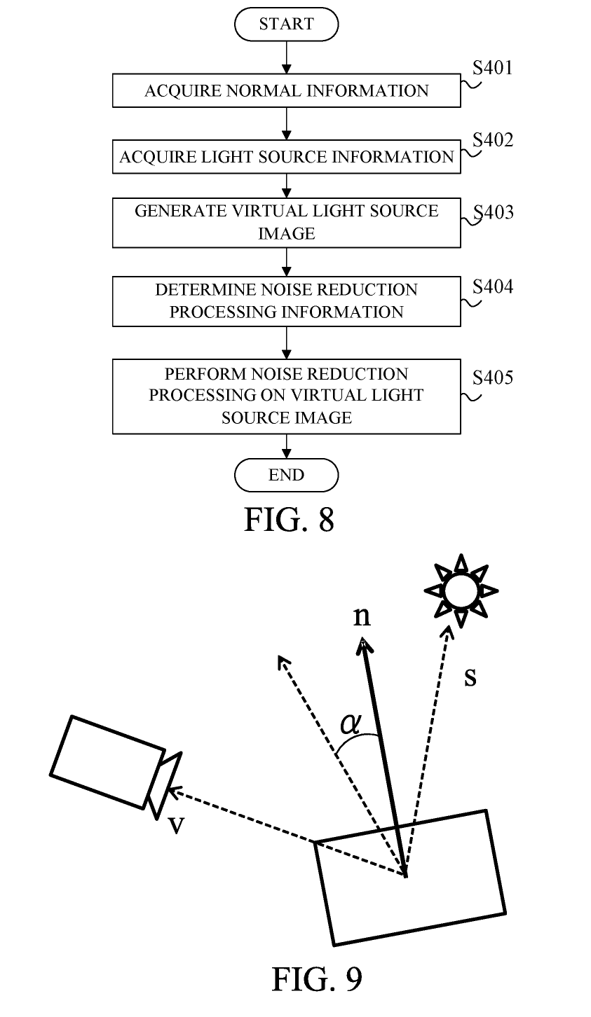

Next, referring to FIG. 8, the noise reduction processing in this embodiment will be described. FIG. 8 is a flowchart of the noise reduction processing in this embodiment. Each step of FIG. 8 is performed by each unit of the image capturing apparatus 100a (image processing apparatus 120a). Steps S401, S402, and S405 in FIG. 8 are the same as steps S101, S102, and S107 of Embodiment 1 described referring to FIG. 1, respectively, and thus descriptions thereof will be omitted.

In this embodiment, since the reflection characteristic which does not depend on the visual line information are used, the visual line information is not used. When the visual line direction is uniform in the screen (image) because the object is sufficiently far away or the like, reflection characteristic information assuming the corresponding visual line direction is used, and thus it is not necessary to acquire the visual line information. In this case, although the visual line information is included in the reflection characteristic information, it can be said that the visual line information is used.

In this embodiment, it is assumed that Lambert reflection is used as the reflection characteristic. With respect to the reflectance of the Lambertian reflection, it affects the luminance of the virtual light source image by the product of the intensity of the incident light, and accordingly it may be a constant value. In this case, since the luminance value of the virtual light source image can be determined as a function of only the light source information including the intensity of the incident light and the normal information, it is not necessary to acquire the parameters of the reflection model. However, calculating the luminance value of the virtual light source image based on the light source information is considered to implicitly assume the reflection characteristic, and accordingly it can be said that the reflection characteristic information is used.

At step S403, differently from step S105, the information acquirer 1102 communicates (transmits) only the normal information and the light source information to the image processor 103. The virtual light source image generator 103a calculates the luminance value of the virtual light source image based on the normal information and the light source information. In other words, the virtual light source image generator 103a applies a calculation method that implicitly assumes the reflection characteristic to calculate the luminance value of the virtual light source image based on the normal information and the light source information.

Subsequently, at step S404, similarly to step S106, data of the virtual light source image noise amount σr are stored in the ROM 105 as a data table associated with the normal information and the light source information, and the virtual light source image noise amount σr is used as the noise reduction information. Differently from step S106, the visual line direction and the reflection characteristic information are not used directly, but when calculating the noise amount data, a method of calculating the luminance value based on the normal information and the light source information is used. Accordingly, the noise reduction information can be determined based on the light source information, the normal information, and the (indirect) reflection characteristic information. While this embodiment describes an example where the visual line information and the reflection characteristic information are not acquired, the light source information does not have to be acquired when a predetermined light source condition, such as reproducing the appearance under the backlight condition and generating a pseudo strobe effect, is only used.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-131322, filed on Jul. 1, 2016, which is hereby incorporated by reference herein in its entirety.

What is claimed is:

1. An image processing apparatus that generates a virtual light source image of an object, comprising:
a generator configured to generate the virtual light source image based on light source information and normal information of the object; and
a determiner configured to determine noise reduction information to be used for noise reduction processing based on the normal information.

2. The image processing apparatus according to claim 1, wherein the determiner is configured to determine the noise reduction information further based on the light source information.

3. The image processing apparatus according to claim 1, wherein the light source information includes information on an intensity of a light source.

4. The image processing apparatus according to claim 1, wherein the light source information includes information on a spatial distribution of a light source.

5. The image processing apparatus according to claim 1, wherein the generator is configured to generate the virtual light source image further based on reflection characteristic information of the object.

6. The image processing apparatus according to claim 5, wherein the determiner is configured to determine the noise reduction information further based on the reflection characteristic information.

7. The image processing apparatus according to claim 6, wherein the determiner is configured to determine the noise reduction information based on a reflectance that is determined by the reflection characteristic information.

8. The image processing apparatus according to claim 6, wherein the determiner is configured to determine the noise reduction information based on a sensitivity of the reflection characteristic information with respect to the normal information.

9. The image processing apparatus according to claim 8, wherein:
the reflection characteristic information is expressed by a parametric model, and
the determiner is configured to determine the noise reduction information based on the sensitivity of the reflection characteristic information with respect to a coefficient of the parametric model.

10. The image processing apparatus according to claim 6, wherein the determiner is configured to determine the noise reduction information based on a luminance value of the virtual light source image that is determined by using the reflection characteristic information.

11. The image processing apparatus according to claim 6, wherein the determiner is configured to determine the noise reduction information further based on reflection characteristic error information.

12. The image processing apparatus according to claim 1, wherein the determiner is configured to determine the noise reduction information further based on normal error information.

13. The image processing apparatus according to claim 1, wherein:
the generator is configured to generate the virtual light source image further based on visual line information, and
the determiner is configured to determine the noise reduction information further based on the visual line information.

14. The image processing apparatus according to claim 1, further comprising a noise reducer configured to perform the noise reduction processing on the virtual light source image by using the noise reduction information.

15. The image processing apparatus according to claim 1, further comprising a noise reducer configured to perform the noise reduction processing on the normal information by using the noise reduction information.

16. The image processing apparatus according to claim 5, further comprising a noise reducer configured to perform the noise reduction processing on the reflection characteristic information by using the noise reduction information.

17. The image processing apparatus according to claim 1, further comprising a noise reducer configured to perform the noise reduction processing on at least one reflection component image that contributes to the virtual light source image by using the noise reduction information.

18. The image processing apparatus according to claim 1, further comprising a noise reducer configured to perform the noise reduction processing on a virtual light source image generated by at least one light source that contributes to the virtual light source image by using the noise reduction information.

19. The image processing apparatus according to claim 1, wherein the noise reduction information is different for each region of the object.

20. The image processing apparatus according to claim 1, wherein the determiner is configured to determine the noise reduction information based on luminance correction processing on the virtual light source image.

21. An image capturing apparatus that generates a virtual light source image of an object, comprising:
an image capturer configured to photoelectrically convert an optical image formed via an image capturing optical system;
a generator configured to generate the virtual light source image based on light source information and normal information of the object that are acquired from the image capturer; and
a determiner configured to determine noise reduction information to be used for noise reduction processing based on the normal information.

22. An image processing method of generating a virtual light source image of an object, the method comprising the steps of:
generating the virtual light source image based on light source information and normal information of the object; and
determining noise reduction information to be used for noise reduction processing based on the normal information.

23. A non-transitory computer-readable storage medium storing an image processing program which causes a computer to execute a process comprising the steps of:
generating the virtual light source image based on light source information and normal information of the object; and
determining noise reduction information to be used for noise reduction processing based on the normal information.
